(19) United States
(12) Patent Application Publication
(10) Pub. No.: US 2026/0342570 A1
(43) Pub. Date: Oct. 29, 2026

(54) SYSTEMS AND METHODS FOR VERIFIABLE APPROVAL

(71) Applicant: BLOCKCHAINS, INC., Reno, NV (US)

(72) Inventors: Julia Ayla Celiker, Dresden (DE); Sebastian Dechant, Oechsen (DE); Roy Michael Dorado, Reno, NV (US); Paul Thomas Hansen, Reno, NV (US); Simon Jentzsch, Mittweida (DE); Jack Joseph Leske, Incline Village, NV (US); Alex Oberhauser, Burlington, MA (US); Lee Weiss, Roslyn, NY (US)

(73) Assignee: BLOCKCHAINS, INC., Reno, NV (US)

(21) Appl. No.: 18/997,337

(22) PCT Filed: Jul. 21, 2023
(86) PCT No.: PCT/US2023/028331

§ 371 Date: Jan. 21, 2025

Related U.S. Application Data
(60) Provisional application No. 63/391,479, filed on Jul. 22, 2022.

(51) Int. Cl. H04L 9/32; H04L 9/30

(52) U.S. Cl. CPC H04L 9/321; H04L 9/30

(57) ABSTRACT

Systems and methods for verifiable approval. In some embodiments, a presentation may be received that is associated with a user requesting access to a selected service. The presentation may comprise a user information credential and an approval credential. A user public key associated with the user may be used to verify the presentation and the user information credential. An approval public key associated with the user may be used to verify the approval credential. In response to successfully verifying the user information credential and the approval credential, the selected service may be provided to the user.

### RELATED APPLICATION

This application claims priority benefit under 35 U.S.C. § 119 (e) to U.S. Provisional Application No. 63/391,479, filed Jul. 22, 2022, entitled “SYSTEMS AND METHODS FOR VERIFIABLE APPROVAL,” which is incorporated by reference herein in its entirety.

### BACKGROUND

Increasingly, children engage in a wide range of online activities, such as playing games, watching videos, connecting with friends on social media, etc. Many parents are concerned about how much time their children spend online, whether there is sufficient safeguard for their children's privacy, whether their children may be exposed to inappropriate content, or become targets of bullying or other abuses, etc.

There are laws and regulations, such as the Children's Online Privacy Protection Act (COPPA), that aim to protect children and their online activities. For instance, a service provider is required to notify parents of what kinds of data the service provider collects, and how the collected data is used and/or disclosed. Moreover, the service provider is required to obtain parental consent prior to collecting data from children under age 13.

### SUMMARY

In accordance with some embodiments, a computer-implemented method is provided for obtaining approval. The method comprises acts of: receiving a presentation associated with a user requesting access to a selected service, the presentation comprising a user information credential and an approval credential; using a user public key associated with the user to verify the presentation and the user information credential; using an approval public key associated with the user to verify the approval credential; and in response to successfully verifying the user information credential and the approval credential, causing the selected service to be provided to the user.

In accordance with some embodiments, a computer-implemented method is provided for obtaining approval. The method comprises acts of: receiving, from an approver, a request to generate a decentralized identifier for a user, the request comprising a public key associated with the user; using a public key associated with the approver to verify a signature purportedly generated by the approver over the request; and in response to successfully verifying the signature: generating a decentralized identifier for the user; and binding the public key associated with the user to the decentralized identifier generated for the user.

In accordance with some embodiments, a system is provided, comprising at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1A shows an illustrative identity management system 100, in accordance with some embodiments.

FIG. 1B shows illustrative identity management agents 105A-B, in accordance with some embodiments.

FIG. 2A shows an illustrative process 200A for onboarding with the illustrative identity management system 100 in the example of FIG. 1A, in accordance with some embodiments.

FIG. 2B shows another illustrative process 250B for onboarding with the illustrative identity management system 100 in the example of FIG. 1A, in accordance with some embodiments.

FIG. 2C shows another illustrative process 200C for onboarding with the illustrative identity management system 100 in the example of FIG. 1A, in accordance with some embodiments.

FIG. 2D shows another illustrative process 250D for onboarding with the illustrative identity management system 100 in the example of FIG. 1A, in accordance with some embodiments.

FIG. 2E shows an illustrative process 250E for establishing a connection between two entities, in accordance with some embodiments.

FIG. 3A shows an illustrative collection 300A of decentralized identifiers (DIDs), in accordance with some embodiments.

FIG. 3B shows another illustrative collection 300B of DIDs, in accordance with some embodiments.

FIG. 3C shows another illustrative collection 300C of DIDs, in accordance with some embodiments.

FIG. 4A shows an illustrative process 400A for verifiable approval, in accordance with some embodiments.

FIG. 4B shows another illustrative process 400B for verifiable approval, in accordance with some embodiments.

FIG. 5 shows, schematically, an illustrative computer 1000 on which any aspect of the present disclosure may be implemented.

### DETAILED DESCRIPTION

Aspects of the present disclosure relate to systems and methods for verifiable approval. For instance, systems and methods are provided for obtaining verifiable parental approval for children's access to online and/or other services.

The inventors have recognized and appreciated that many techniques for obtaining parental approval are overly burdensome and/or easily circumvented. As a result, some service providers simply choose not to offer their services to children under age 13. Others make a nominal attempt to comply with COPPA and associated regulations, and simply pay a fine if the Federal Trade Commission (FTC), the responsible federal agency, brings an enforcement action.

For instance, some service providers have knowledge of a child's age, but fail to obtain parental approval prior to collecting data from the child. Others attempt to obtain parental approval, but fail to provide notice of relevant data collection, use, and disclosure practices. Yet others put such a notice in legal fine print behind a link that parents rarely click through, instead of displaying the notice prominently when seeking parental approval.

Moreover, if a service provider's records indicate parental approval has been obtained for a child, there may be no reliable way to verify that approval has indeed been obtained, or that the approval, if obtained, is indeed given by a parent of that particular child.

Accordingly, in some embodiments, techniques are provided for obtaining approval that is readily verifiable. For instance, an approval may be represented by a data structure that is cryptographically signed using a private key of a suitable approver, such as a parent of a child seeking access to a service. Thus, a public key of the approver may be used to verify that an alleged approval is indeed given by the approver.

In some embodiments, the data structure that is cryptographically signed includes one or more notices to the approver. For instance, the data structure may indicate one or more types of data to be collected from the child by a provider of the service. Additionally, or alternatively, the data structure may indicate one or more uses of the collected data, and/or one or more ways in which the collected data may be disclosed. Thus, the approver's signature may show that the approver has received such notice(s).

The inventors have further recognized and appreciated that many parental control mechanisms are based on federated identities. For instance, parental control settings may be applied to an account at a service provider, where the account may be associated with an identifier issued by a third party (e.g., an email address issued by an email provider). If the same identifier is used to open accounts at different service providers, activities across the service providers may be tracked readily, which may compromise privacy.

Accordingly, in some embodiments, techniques are provided for obtaining approval based on decentralized identities. For instance, a child may have different identifiers (e.g., self-issued, or issued by a parent or an identity management system), to be used to open accounts at different service providers. In this manner, the child's activities across the service providers may not be tracked readily.

The inventors have further recognized and appreciated that, to protect their children, parents typically have to navigate through a patchwork of parental controls that is confusing and cumbersome. For instance, some parental controls are available on devices (e.g., gaming devices such as PlayStation, Xbox, Nintendo Switch, etc., and general-purpose devices such as smartphones, tablets, etc.), whereas other parental controls are available via service providers. Thus, parents may have to set parental controls on multiple devices and via multiple service providers, where each device or service provider may have its own assortment of available settings.

Moreover, to prevent a child from modifying settings selected by a parent, the parent may be prompted to establish a parental control password that is separate from a login password. As a result, the parent may have to keep track of multiple passwords for each device or service provider.

Accordingly, in some embodiments, techniques are provided for obtaining fine-grained approval in a manner that is consistent across multiple devices and/or service providers. For instance, as described above, an approval may be represented by a data structure that is cryptographically signed using a private key of a suitable approver, such as a parent of a child seeking access to a service. Such an approval data structure may include one or more access permissions and/or restrictions, so that the approver's signature may show that the approver has given such permission(s) and/or set such restriction(s).

As an example, the approval data structure may indicate a content rating according to a suitable authority, such as the Entertainment Software Rating Board (ESRB). As another example, the approval data structure may indicate one or more time periods during which the child may or may not access the service. As another example, the approval data structure may indicate a budget for purchases on a periodic basis (e.g., daily, weekly, monthly, etc.).

Thus, in some embodiments, a common parental control interface may be provided that allows a parent to manage different aspects of a child's access to different services. For instance, the parent may use the common interface to create, for each approved service, a separate approval data structure indicating permissions and/or restrictions pertaining to that service.

In some embodiments, the common parental control interface may be implemented using a self-sovereign identity (SSI) system, where the child's identity may be managed as a profile under the parent's identity. The child's identity may have further profiles thereunder, where each profile may correspond to a respective approved service, and may be associated with the approval data structure for that service.

Additionally, or alternatively, the child may have multiple identifiers, where each identifier may be used to identify the child to a respective service provider. An approval data structure to be presented to a given service provider may include the child's identifier with respect to that service provider. In this manner, the child's activities across different service providers may be protected from correlation.

It should be appreciated that the techniques introduced above and/or described in greater detail below may be implemented in any of numerous ways, as these techniques are not limited to any particular manner of implementation. Examples of implementation details are provided herein solely for purposes of illustration. Furthermore, the techniques described herein may be used individually or in any suitable combination, as aspects of the present disclosure are not limited to any particular technique or combination of techniques.

It should also be appreciated that, when parental controls are discussed, “parent” may refer to not only a biological or adoptive parent, but also a non-parent guardian, a teacher, or any other individual with authority to approve a child's access to a service in a given setting (e.g., home, school, after-school care, summer camp, etc.).

Furthermore, when parental controls are discussed, “child” may refer to not only a child under a certain age (e.g., 13, 16, 18, 21, etc.), but also any individual being cared for by a guardian, such as an elderly person, a person with an intellectual disability, etc. Such an individual is sometimes referred to herein as a ward of the guardian.

Further still, although parental controls are mentioned throughout the present disclosure, it should be appreciated that the techniques described herein may be applied in any suitable use case, in addition to, or instead of, parental controls. For instance, one or more of the techniques described herein may be used to obtain a manager's approval for a worker's access to certain information, physical equipment, physical space, software program, etc.

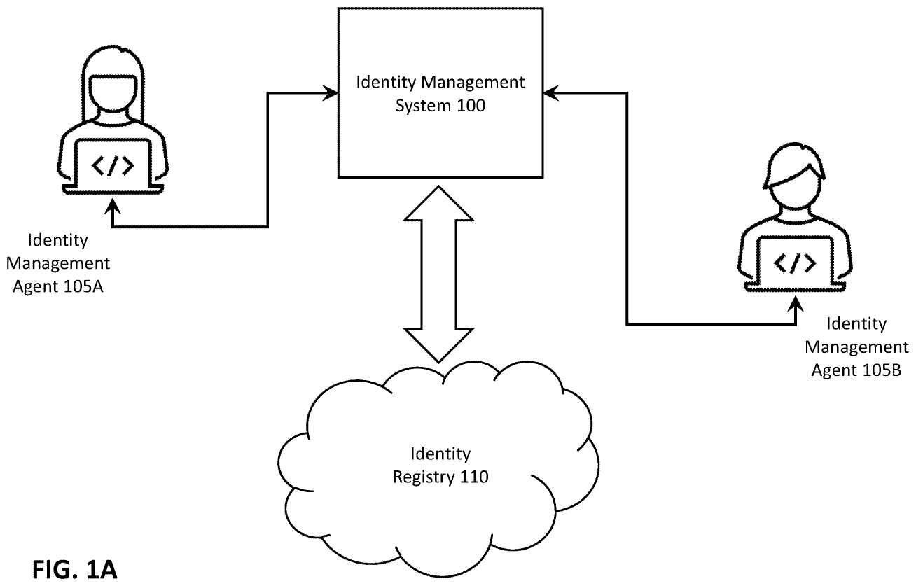

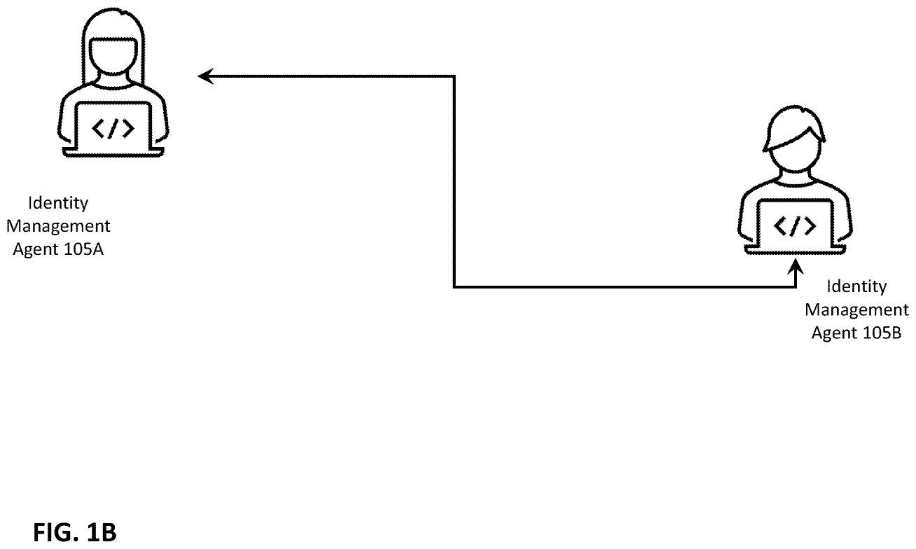

FIG. 1A shows an illustrative identity management system 100, in accordance with some embodiments. For instance, the identity management system 100 may be used by a parent to approve a child's access to services.

In some embodiments, the identity management system 100 may be hosted on one or more servers. Any suitable computing infrastructure may be used, such as an on-premises infrastructure and/or a cloud infrastructure.

In some embodiments, a user may access the identity management system 100 via an identity management agent. For instance, a parent may use an identity management agent 105A, while a child may use an identity management agent 105B. The identity management agents 105A-B may run on different devices, or the same device. For instance, the identity management agents 105A-B may be different instances of the same identity management software running on different devices, or the same device (e.g., from different user accounts or the same user account).

An identity management agent may be implemented in any suitable manner. As an example, an identity management agent may include a web browser configured to execute one or more software scripts (e.g., in JavaScript) received from the identity management system 100. As another example, an identity management agent may include stand-alone software installed on a user device (e.g., a desktop, or a mobile device such as a laptop, a tablet, a smartphone, etc.). The stand-alone software may be configured to communicate with the identity management system 100 via one or more remote application programming interfaces (APIs).

In some embodiments, an identity management agent may communicate with the identity management system 100 via one or more network interfaces. Such a network interface may use any suitable networking technology, such as 5G, LTE, WiMAX, WiFi, Ethernet, Bluetooth, etc.

As discussed above, the inventors have recognized and appreciated that it may be beneficial to obtain approval based on decentralized identities. Accordingly, in some embodiments, the identity management system 100 may be an SSI system. For instance, the identity management system 100 may implement one or more specifications provided by the Decentralized Identity Foundation (DIF) for issuing decentralized identifiers (DIDs), verifiable credentials (VCs), verifiable presentations (VPs), etc.

In some embodiments, a DID may identify a subject, which may be a natural person, an organization, a physical object, a physical space, a virtual object, a virtual space, a software program, etc. The DID may have an associated DID document, which may include any suitable information about the subject of the DID. Examples of such information include, but are not limited to, a description of the subject, one or more methods for verifying that an entity purporting to be a controller of the DID (who may be the same as, or different from, the subject) is indeed such a controller, one or more methods for interacting with the subject of the DID, etc.

In some embodiments, a subject may have multiple DIDs. For instance, a subject may have different DIDs corresponding, respectively, to different contexts, where each context may include one or more counterparties (e.g., friends, service providers, etc.). Such a DID is sometimes referred to herein as an N-way DID. A 2-way DID is sometimes referred to herein as a pairwise DID.

In some embodiments, a DID document for an N-way DID may include any suitable information about a counterparty, such as a DID of the counterparty, a Uniform Resource Locator (URL) associated with the counterparty, a description of one or more services provided by the counterparty, one or more methods for interacting with the counterparty, etc. However, it should be appreciated that aspects of the present disclosure are not limited to storing any particular information about a counterparty in a DID document, or any such information at all.

In some embodiments, a DID may be published to an identity registry, along with information that may be used to obtain an associated DID document (e.g., the DID document itself, and/or information that may be used to resolve the DID into the DID document). In this manner, upon encountering the DID, any entity with access to the identity registry may use the DID to obtain the associated DID document.

However, it should be appreciated that aspects of the present disclosure are not limited to publishing a DID, or information for use in obtaining an associated DID document, to an identity registry. For instance, in some embodiments, an N-way DID (e.g., a pairwise DID or a 3-way DID), along with information that may be used to obtain an associated DID document, may be provided directly to one or more counterparties.

Returning to the example of FIG. 1A, the identity management system 100 publishes DIDs to an identity registry 110, which may be implemented in any suitable manner. For instance, the identity registry 110 may be implemented using a distributed ledger, which may be maintained collectively by a network of nodes. Such nodes may be referred to herein as layer 1 nodes, and may be operated by the same entity or different entities. An entity of any suitable type may operate a layer 1 node, such as an individual user, a private organization, a government agency, etc.

Additionally, or alternatively, the identity registry 110 may be implemented using one or more layer 2 techniques. For instance, an overlay network of nodes may participate in a Sidetree protocol according to a specification provided by DIF. These nodes may be referred to herein as layer 2 nodes. Like layer 1 nodes, layer 2 nodes may be operated by the same entity or different entities. An entity of any suitable type may operate a layer 2 node, such as an individual user, a private organization, a government agency, etc. Moreover, in some instances, an entity may operate both a layer 1 node and a layer 2 node.

In some embodiments, the layer 2 nodes may maintain, for each DID, a sequence of operations performed with respect to the DID (e.g., Create, Update, Recover, Deactivate, etc.). These operations may be stored in any suitable manner, for instance, using a content addressable and/or distributed storage system. As an example, a storage system may be used that implements an InterPlanetary File System (IPFS) protocol.

Additionally, or alternatively, the layer 2 nodes may enforce one or more rules for creating a new DID in the identity registry 110, updating information recorded with the DID (e.g., an associated DID document and/or information for use in resolving the DID into the DID document), removing the DID from the identity registry 110, etc. For instance, the layer 2 nodes may use a public key associated with a DID to verify whether a proposed update has been signed using a corresponding private key. Thus, an entity using the identity registry 110 to obtain a DID document may be able to trust that the DID document is accurate and authentic.

Additionally, or alternatively, the layer 2 nodes may interact with the underlying distributed ledger to ensure an ordering of the DID operations that is consistent across all layer 2 nodes. For instance, each DID operation may be represented by a respective value, and an ordering of the values may be recorded on the distributed ledger.

The values representing the DID operations may be chosen in any suitable manner. In some embodiments, a DID operation may be hashed to obtain a corresponding value. Additionally, or alternatively, a key to the DID operation in a content addressable storage may be used the corresponding value.

In some embodiments, the distributed ledger may include digital records replicated among one or more layer 1 nodes in the network. The layer 1 nodes may carry out a synchronization protocol, whereby a transaction that changes a digital record may be propagated through the network, and all layer 1 nodes may update their respective copies of that digital record accordingly.

In some embodiments, the distributed ledger may be implemented using a blockchain. The blockchain may include a plurality of blocks, where each block may include a plurality of transactions that are ordered chronologically, or in some other suitable manner. Additionally, or alternatively, each newly added block may be linked to a latest previous block. For instance, the new block may include a cryptographic hash of the previous block. Such a structure may provide tamper resistance, and may therefore be used to confirm whether a given transaction did take place, and/or when that transaction took place relative to one or more other transactions.

In some embodiments, a new block may be added to the blockchain only if all layer 1 nodes in the network, or a subset of layer 1 nodes with sufficient computation power, agree on the block. Any suitable distributed consensus technique may be used to reach an agreement. For instance, the fastest layer 1 node to solve a computationally intensive mathematical puzzle (e.g., identifying a preimage of a hash with a certain number of leading zeros) may be selected to add the next block. Depending on how much computation power is available in the network at a given point in time, a more or less complex mathematical puzzle may be used, so that each new block may be added within a selected window of time.

In this manner, a malicious entity may have to control a large portion (e.g., more than 50%) of the network's computation power to mount a successful attack. To incentivize participation of honest entities, a layer 1 node may be rewarded with an internal digital asset (e.g., a bitcoin) each time that layer 1 node is selected to add the next block.

It should be appreciated that aspects of the present disclosure are not limited to using a proof-of-work approach to achieve distributed consensus. Additionally, or alternatively, a proof-of-stake approach may be used, where layer 1 nodes are selected according to their respective stakes in a cryptocurrency. It should also be appreciated that any suitable blockchain implementation may be used, such as Ethereum, Hyperledger Fabric, etc.

Furthermore, aspects of the present disclosure are not limited to using a blockchain to implement a distributed ledger. In some embodiments, one or more directed acyclic graphs (e.g., IOTA Tangle), hashgraphs (e.g., Swirlds), hash trees (e.g., Guardtime keyless signatures infrastructure), and/or distributed ledgers with no globally-shared chain (e.g., R3 Corda), may be used in addition to, or instead of, one or more blockchains.

Referring again to the example of FIG. 1A, a smart contract (not shown) may be deployed on the distributed ledger to maintain an ordering of the DID operations that is consistent across all layer 2 nodes. For instance, the smart contract may process transactions whereby DID operations (or corresponding values) may be recorded on the distributed ledger. Each such transaction may include one DID operation (or corresponding value), or multiple DID operations (or corresponding values) in a given ordering. Thus, a transaction history of the smart contract may be used to determine an ordering of all recorded DID operations.

The smart contract may include any suitable program logic, such as program logic that indicates one or more events and/or one or more actions to be performed in response to the one or more events. For instance, an event may include a transaction involving the smart contract, and a corresponding action may include an update to a state of the smart contract as a result of the transaction. Such a smart contract may be deployed via a transaction, whereby program logic of the smart contract may be recorded on the distributed ledger.

In some embodiments, the smart contract may be enforced collectively by the network of layer 1 nodes maintaining the distributed ledger. Each layer 1 node may maintain a respective copy of the smart contract, which may include program logic and/or a state of the smart contract. When a transaction involving the smart contract is propagated through the network of layer 1 nodes, each layer 1 node may independently execute the program logic of the smart contract to determine how to update the state of the smart contract.

It should be appreciated that aspects of the present disclosure are not limited to using a smart contract deployed on the distributed ledger to maintain an ordering of DID operations. In some embodiments, one or more functionalities of the smart contract may be performed off ledger. For instance, DID operations (or corresponding values) may be encoded into transactions that are processed by a layer 2 service. One or more transaction rules may be enforced by the layer 2 service, or some other off-ledger software, to maintain an appropriate ordering. Transaction data encoding the DID operations (or the corresponding values) may then be used to determine an ordering of the DID operations based on an ordering of the transactions.

While certain implementation details are described above in connection with FIG. 1A, it should be appreciated that such details are provided solely for purposes of illustration. For instance, aspects of the present disclosure are not limited to implementing all identity management agents in a common manner. In some embodiments, the identity management agent 105A may be provided via a web browser, whereas the identity management agent 105B may be provided as a stand-alone application running on a user device, or vice versa.

Additionally, or alternatively, one or more of the functionalities described herein for the identity management system 100 and/or the identity registry 110 may be performed by an identity management agent running on a user device, such as the identity management agent 105A and/or the identity management agent 105B.

FIG. 1B shows the identity management agents 105A-B interacting directly with each other, in accordance with some embodiments. For instance, the identity management agents 105A-B may communicate via a secure channel (e.g., with encryption and/or authentication). Any suitable secure channel may be used, such as a channel implementing a DIDComm Messaging specification provided by DIF.

DIDComm Messaging provides secure peer-to-peer communication. Thus, the identity management agents 105A-B may be able to communicate without exposing data to any centralized service. (By contrast, for example, communication via email may be subject to monitoring by an email service provider.) However, it should be appreciated that aspects of the present disclosure are not limited to using DIDComm Messaging or any other peer-to-peer communication protocol.

In some embodiments, the identity management agent 105A and/or the identity management agent 105B may each maintain, locally on the respective user device, a private registry for one or more DIDs (e.g., one or more N-way DIDs identifying the user of the device in, respectively, one or more different contexts).

Accordingly, the identity management agent 105A and/or the identity management agent 105B may perform one or more of the illustrative tasks described above in connection with the layer 2 nodes, such as maintaining, for each DID, a sequence of operations performed with respect to the DID (e.g., Create, Update, Recover, Deactivate, etc.), and/or enforcing one or more rules for creating a new DID, updating information recorded with the DID (e.g., an associated DID document and/or information for use in resolving the DID into the DID document), removing the DID, etc. For instance, the identity management agent 105A and/or the identity management agent 105B may use a public key associated with a DID to verify whether a proposed update has been signed using a corresponding private key.

It should be appreciated that aspects of the present disclosure are not limited to any particular specification of DIDs, or any particular implementation thereof. Indeed, aspects of the present disclosure are not limited to having an SSI system, or any decentralized identity system at all.

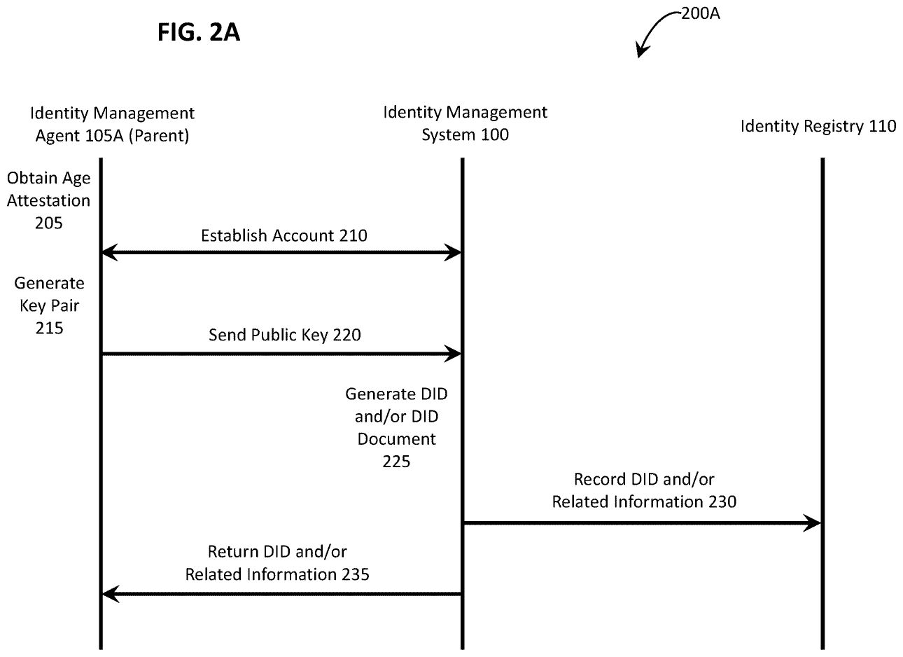

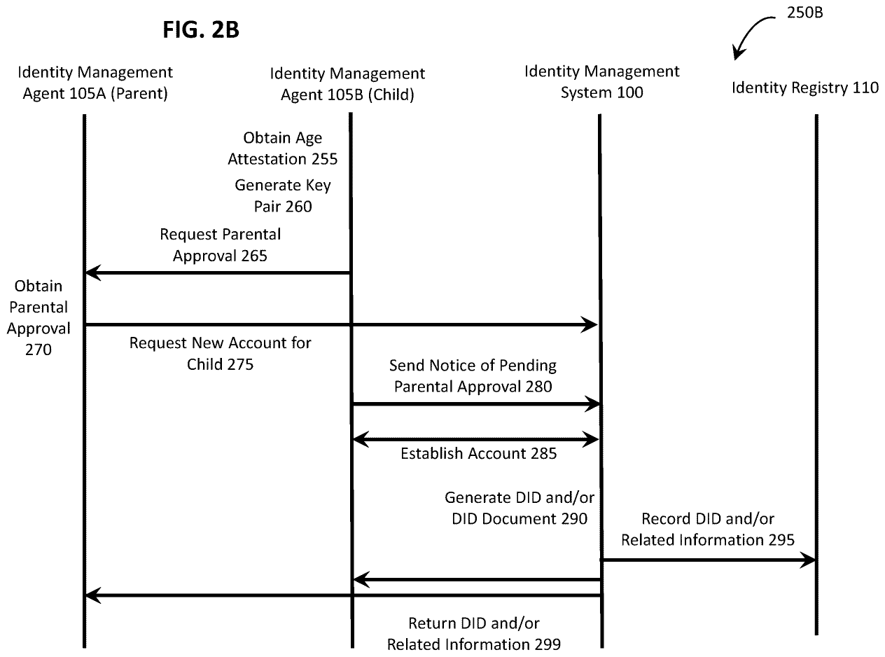

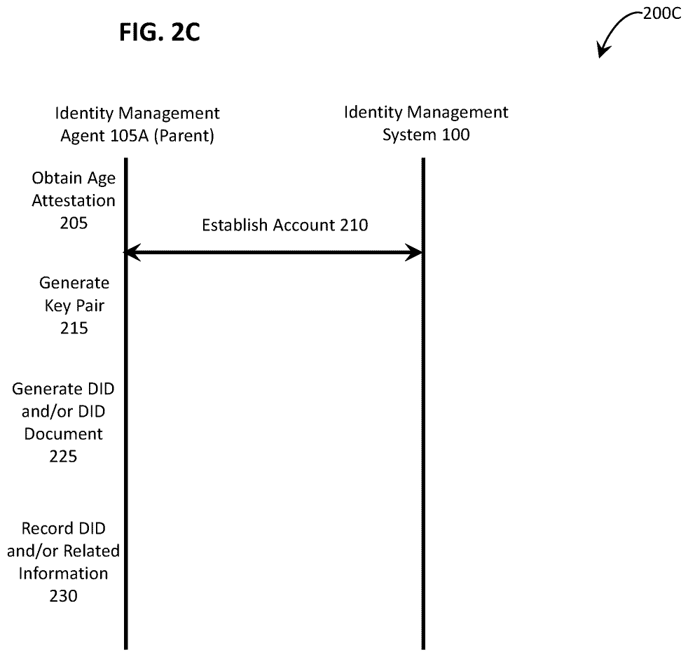

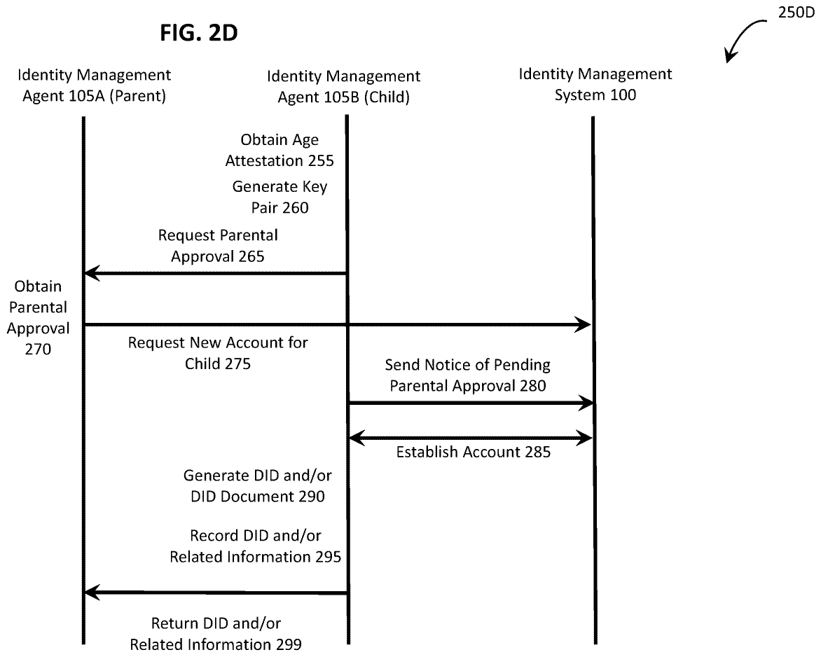

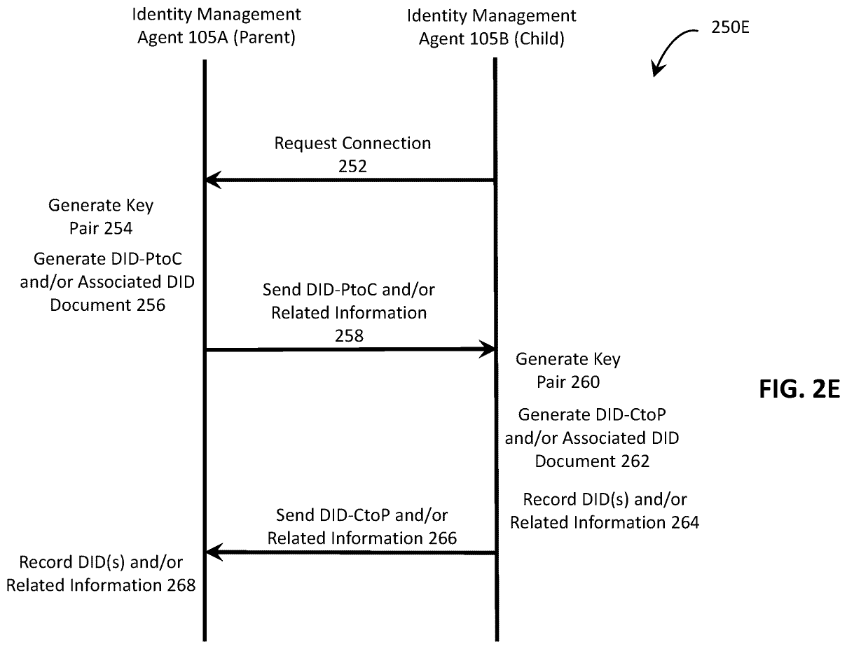

FIG. 2A shows an illustrative process 200A for onboarding with the illustrative identity management system 100 in the example of FIG. 1A, in accordance with some embodiments. For instance, the process 200A may be triggered when a user attempts to onboard with the identity management system 100. The user may do so in any suitable manner, for example, by launching the illustrative identity management agent 105A on a user device (e.g., via a web browser or as a stand-alone app).

At act 205, the identity management agent 105A may prompt the user for a “self-attestation” to attest whether the user is an adult. It should be appreciated that “adult” may refer to any individual whose age is above a selected threshold (e.g., 13 years, 16 years, 18 years, 21 years, etc.). The threshold may be selected in any suitable manner, for example, according to a relevant law or regulation.

For instance, the identity management agent 105A may prompt the user to enter a date of birth, or otherwise indicate the user's age.

In some embodiments, if the user's self-attestation indicates the user may be an adult, the identity management agent 105A may prompt the user to provide a government-issued identification document (e.g., a driver's license, a passport, etc.). The identity management agent 105A may capture an image of the identification document, and may analyze the image, and/or send the image to the identity management system 100 for analysis. For example, pertinent information may be extracted from the image of the identification document, such as the user's image, name, address, date of birth, citizenship, etc.

Additionally, or alternatively, the identity management agent 105A may prompt the user to provide an attestation from a notary or some other trusted entity (e.g., a government agency that issues driver's licenses). For instance, the trusted entity may examine one or more physical documents (e.g., a government-issued identification document such as a passport, a driver's license, etc.) to obtain one or more items of pertinent information (e.g., the user's image, name, address, date of birth, citizenship, etc.). The trusted entity may attest to the extracted information by storing the extracted information, and/or information derived therefrom (e.g., the user's image, age, etc.), in a suitable data structure, and using a private key of the trusted entity to electronically sign the data structure. A corresponding public key of the trusted entity may be made available in a suitable manner, and may be used by the identity management agent 105A to verify the signature over the data structure.

In some embodiments, the data structure may be prepared according to a Verifiable Credential specification provided by DIF. However, it should be appreciated that aspects of the present disclosure are not so limited.

In some embodiments, one or more facial recognition techniques may be used to compare an image of the user captured in real time by the identity management agent 105A against the image extracted from the government-issued identification document or the trusted party's attestation.

Upon receiving an attestation that the user is an adult, the identity management agent 105A may, at act 210, interact with the identity management system 100 to establish an account for the user. For instance, the account may be associated with a username and/or one or more login credentials, such as a password, a biometric pattern (e.g., fingerprint, face scan, voiceprint, iris scan, etc.), etc.

Additionally, or alternatively, one or more methods of multi-factor authentication may be established. For example, the identity management agent 105A may prompt the user to provide an email address and/or a phone number, and the identity management system 100 may send a code to the email address and/or the phone number. The code may be randomly generated, and the user may enter the code into the identity management agent 105A to show that the user indeed has access to the email address and/or the phone number.

At act 215, the identity management agent 105A may generate a cryptographic key pair, which may include a private key and a corresponding public key. The key pair may be generated in any suitable manner. For instance, the identity management agent 105A may generate a random seed, which may be a string of numbers of any suitable length (e.g., 12, 18, 24, etc. words). The random seed may then be used to generate the private key and the corresponding public key. In this manner, if the user loses the private key, the random seed may be used to recover the private key.

As described below, the user's private key may be used to generate a signature to show the user has given certain approval, and the public key may be used to verify such a signature.

Accordingly, in some embodiments, the public key may be sent to the identity management system 100 at act 220, whereas the private key and the random seed may remain on the user device. In this manner, the identity management system 100 may not be able to spoof the user's approval.

However, it should be appreciated that aspects of the present disclosure are not limited to storing the private key and the random seed on the user device. Additionally, or alternatively, the private key and/or and the random seed may be stored in a separate secure storage, such as a hardware wallet.

At act 225, the identity management system 100 may generate a DID, and may associate the DID with the account established at act 210. Additionally, or alternatively, the identity management system 100 may generate an associated DID document. For instance, the DID document may store the public key received at act 220, and may indicate that, if an entity is able to generate a signature that is successfully verified with the public key, then that entity may be considered a controller of the DID. In this manner, the DID document may bind the public key to the DID.

At act 230, the identity management system 100 may record the DID generated at act 225 in an identity registry, such as the illustrative identity registry 110 in the example of FIG. 1A. Additionally, or alternatively, the identity management system 100 may record related information, such as the DID document itself, and/or information that may be used to resolve the DID into the DID document. This may be done in any suitable manner, for example, via a Create operation.

At act 235, the identity management system 100 may return the DID generated at act 225 and/or the related information to the identity management agent 105A, which may store the DID and/or the related information on the user device.

While certain implementation details are described above in connection with FIG. 2A, it should be appreciated that such details are provided solely for purposes of illustration. For instance, aspects of the present disclosure are not limited to using the identity registry 110. In some embodiments, the identity management agent 105A may, upon receiving the DID and/or the related information at act 235, record the DID and/or the related information in a private registry maintained on the user device.

Additionally, or alternatively, acts 210 and 220 may be omitted, and the DID and/or the DID document may be generated, at act 225, by the identity management agent 105A. Then, at act 230, the identity management agent 105A may record the DID and/or the related information in a private registry maintained on the user device. Such an illustrative process 200C is shown in FIG. 2C.

FIG. 2B shows another illustrative process 250B for onboarding with the illustrative identity management system 100 in the example of FIG. 1A, in accordance with some embodiments. Similar to the illustrative process 200A in the example of FIG. 2A, the process 250B may be triggered when a user attempts to onboard with the identity management system 100. The user may do so via the illustrative identity management agent 105B.

At act 255, the identity management agent 105B may prompt the user to attest whether the user is an adult. For instance, the identity management agent 105B may prompt the user to enter a date of birth, or otherwise indicate the user's age.

In this example, the identity management agent 105B determines that the user may be a child (i.e., not an adult). Accordingly, instead of establishing an account right away, the identity management agent 105B may attempt to obtain parental approval, for example, as described below in connection with acts 260 and 265.

In some embodiments, while parental approval is still pending, the identity management agent 105B may not collect identity information from the child, or may collect only a limited set of identity information, such as a nickname, a parent's phone number, a parent's email address, etc.

At act 260, the identity management agent 105B may generate a cryptographic key pair, which may include a private key and a corresponding public key. The key pair may be generated in any suitable manner, for instance, as described above in connection with act 215 in the example of FIG. 2A.

At act 265, the identity management agent 105B may prompt the child to obtain parental approval. For instance, the identity management agent 105B may display a QR code, with an instruction to have a parent scan the QR code with the parent's device (e.g., the parent's smartphone). The QR code may be configured to cause the parent's device to launch the illustrative identity management agent 105A in the example of FIG. 1A.

Additionally, or alternatively, the identity management agent 105B may prompt the child to enter the parent's email address and/or phone number, and may forward the email address and/or the phone number provided by the child to the identity management system 100. The identity management system 100 may then email and/or text a link to the parent to launch the identity management agent 105A.

In some embodiments, the QR code or the link provided to the parent may encode information that identifies the identity management agent 105B used by the child. For instance, the identity management agent 105B may have an identifier (e.g., a randomly generated alphanumeric string) that cannot be traced to the child's real world identity. This identifier may be encoded into the QR code or the link.

In some embodiments, if the parent has not already established an account with the identity management system 100, the process 200A in the example of FIG. 2A may be triggered to onboard the parent. If/when the parent has been onboarded, the identity management agent 105A may, at act 270, prompt the parent to approve the child's onboarding with the identity management system 100.

Additionally, or alternatively, the identity management agent 105A may prompt the parent to provide an attestation that the parent has authority to grant approval for the child. As an example, the identity management agent 105A may accept the parent's self-attestation.

As another example, the identity management agent 105A may request an attestation from a notary or some other trusted entity. For instance, the trusted entity may examine one or more physical documents, such as the child's birth certificate, and may provide an attestation that is electronically signed using a private key of the trusted entity. A corresponding public key may be made available in a suitable manner, and may be used by the identity management agent 105A to verify the signature over the attestation.

In some embodiments, the trusted entity's attestation may be prepared according to a Verifiable Credential specification provided by DIF. However, it should be appreciated that aspects of the present disclosure are not so limited.

Upon receiving the parent's approval and/or the attestation of authority, the identity management agent 105A may, at act 275, send a request to the identity management system 100 to establish an account for the child.

In some embodiments, the identity management agent 105A may use a private key of the parent to sign the request of act 275, and the identity management system 100 may use a corresponding public key to verify the signature. As described in connection with the example of FIG. 2A, the private key may be generated at act 215, and the public key may be sent to the identity management system 100 at act 220.

In some embodiments, a data structure over which the signature is generated may include a nonce. This may improve security, for example, by preventing a replay attack where an attacker attempts to re-use the parent's approval.

Referring again to the example of FIG. 2B, the identity management agent 105B used by the child may, at act 280, notify the identity management system 100 that the child has attempted to establish an account, and that parental approval has been obtained (or is forthcoming). The identity management system 100 may, in response to the request received at act 275 and/or the notification received at act 280, match the parent to the child, for example, by matching the identity management agent 105A used by the parent to the identity management agent 105B used by the child.

For instance, the request of act 275 from the identity management agent 105A may include an identifier for the identity management agent 105B. Additionally, or alternatively, the request of act 275 and the notification of act 280 may both include the public key generated at act 260, which may be used to match the identity management agent 105A to the identity management agent 105B.

Additionally, or alternatively, the identity management agent 105B may, at act 255, collect from the child some identity information of the parent (e.g., the parent's email address or phone number), and may provide that information to the identity management system 100 in the notification of act 280. The identity management system 100 may in turn use the information to match the parent to the child. Additionally, or alternatively, the request of act 275 and the notification of act 280 may both include some identity information of the child (e.g., a nickname), which may be used to match the parent to the child.

At act 285, the identity management system 100 may interact with the identity management agent 105B to establish an account for the child. This may be done in any suitable manner, for instance, as described above in connection with act 210 in the example of FIG. 2A.

At act 290, the identity management system 100 may generate a DID, and may associate the DID with the account established at act 285. Additionally, or alternatively, the identity management system 100 may generate an associated DID document.

In some embodiments, the request sent by the identity management agent 105A to the identity management system 100 at act 275 may include the public key generated by the identity management agent 105B at act 260 (hereafter, the child's public key). For instance, the child's public key may be encoded into the QR code scanned by the parent's device to launch the identity management agent 105A, thereby making the child's public key known to the identity management agent 105A. Additionally, or alternatively, the child's public key may be sent to the identity management system 100 along with the email address and/or the phone number of the parent, and may be encoded into the link for launching the identity management agent 105A.

The inventors have recognized and appreciated that, by including the child's public key in the request of act 275, the identity management system 100 may be assured that the parent's approval is given specifically for that public key. This may improve security, for example, by preventing a replay attack where an attacker attempts to re-use the parent's approval for a different public key.

However, it should be appreciated that aspects of the present disclosure are not limited to including the child's public key in the request of act 275. In some embodiments, the child's public key may be provided to the identity management system 100 by the identity management agent 105B used by the child.

In some embodiments, the identity management system 100 may bind the child's public key to the DID generated at act 290. For instance, the DID document generated at act 290 may store the child's public key, and may indicate that, if an entity is able to generate a signature that is successfully verified with the child's public key, then that entity may be considered a controller of the DID.

The inventors have recognized and appreciated that, in some instances, it may be desirable to have the parent's approval for certain actions (e.g., in-game purchases over a certain cumulative or one-time threshold, trading of cryptocurrencies, etc.), whereas the child may be allowed to perform other actions without parental approval. Accordingly, in some embodiments, the DID document generated at act 290 may store both the child's public key and the parent's public key, and may indicate that certain actions require not only a signature that is successfully verified with the child's public key, but also a signature that is successfully verified with the parent's public key.

Additionally, or alternatively, the DID document generated at act 290 may indicate that, if an entity is able to generate a signature that is successfully verified with the child's public key or the parent's public key, then that entity may be considered a controller of the DID. In this manner, the parent may have full access to, and control over, the child's account.

In some embodiments, the DID generated at act 290 may be an N-way DID, such as a pairwise DID identifying the child with respect to the parent. Accordingly, the DID document generated at act 290 may include some suitable information about the parent, which may be provided by the identity management agent 105A to the identity management agent 105B in response to obtaining parental approval at act 270. Examples of such information include, but are not limited to, the parent's DID, a service endpoint for the parent (e.g., in a peer-to-peer communication network), etc.

At act 295, the identity management system 100 may record the DID generated at act 290, and/or related information, in an identity registry, such as the illustrative identity registry 110 in the example of FIG. 1A. This may be done in any suitable manner, for instance, as described above in connection with act 230 in the example of FIG. 2A.

At act 299, the identity management system 100 may return the DID generated at act 290, and/or the related information, to the identity management agent 105B, which may store the DID and/or the related information on the child's device. Additionally, or alternatively, the identity management system 100 may return the DID generated at act 290, and/or the related information, to the identity management agent 105A, which may store the DID and/or the related information on the parent's device.

The inventors have recognized and appreciated that a user (e.g., the child) may inadvertently delete, or otherwise lose access to, a private key associated with the user's DID. In that event, it may be desirable to allow the user to associate a new key pair with the DID. Accordingly, in some embodiments, the identity management system 100 may, at act 290 in the example of FIG. 2B, generate a key pair (hereafter, the recovery key pair for the child), and store a public key of that key pair in the child's DID document.

If, subsequently, the child loses access to the child's private key (hereafter, the child's old private key), the identity management agent 105B may generate a new key pair, and may send a public key of that key pair (hereafter, the child's new public key) to the identity management system 100. In response, the identity management system 100 may send a Recover operation to the identity registry 110. The Recover operation may include the child's new public key, and may be signed by the identity management system 100 using the recovery private key for the child.

The identity registry 110 may verify the signature using the recovery public key for the child, which is stored in the child's DID document. In response to successfully verifying the signature, the identity registry 110 may accept the Recover operation. Accordingly, a subsequent attempt to resolve the child's DID may result in a DID document that includes the child's new public key.

If, subsequently, the parent loses access to the parent's private key (hereafter, the parent's old private key), the identity management agent 105A may generate a new key pair, and may send a public key of that key pair (hereafter, the parent's new public key) to the identity management system 100. In response, the identity management system 100 may send a Recover operation with the parent's new public key, and the identity registry 110 may process the Recover operation, in a manner similar to that described above for replacing the child's public key.

Additionally, or alternatively, the identity management system 100 may use a Recover operation to replace the parent's public key with another individual's public key. The identity management system 100 may do so, for example, in response to receiving a duly issued court order granting custody of the child to the other individual.

In some embodiments, the identity registry 110 may notify the parent prior to accepting a Recover operation. For instance, the identity registry 110 may identify, from the child's DID document, a service endpoint for the parent. The identity registry 110 may send a notification to that service endpoint, and may postpone accepting the Recover operation until a selected amount of time has elapsed since the notification is sent. If, during this waiting period, the identity registry 110 receives a veto message, and successfully verifies the veto message using the parent's public key (which is stored in the child's DID document), the identity registry 110 may reject the Recover operation.

While a parental notification may improve security, the inventors have recognized and appreciated that it may be undesirable to allow a parent to veto unilaterally. For instance, a parent losing custody may be embittered, and may veto despite a court order. Accordingly, in some embodiments, an M-out-of-N signature scheme may be used, where M is strictly less than N (e.g., 2-out-of-3). For instance, the child's DID document may store two parental public keys corresponding, respectively, to two parents of the child. The identity registry 110 may accept an Update operation to remove one parent from the child DID document if the Update operation is successfully verified using the child's public key and the other parent's public key. Although certain implementation details are described above in connection with FIG. 2B, it should be appreciated that such details are provided solely for purposes of illustration. For instance, aspects of the present disclosure are not limited to using the identity registry 110. In some embodiments, the identity management agent 105B may, upon receiving the DID and/or the related information at act 299, record the DID and/or the related information in a private registry maintained on the child's device. Additionally, or alternatively, the private registry may process Recover operations in manners similar to those described above for the identity registry 110.

It should also be appreciated that aspects of the present disclosure are not limited to distributing functionalities among the identity management system 100 and the identity management agents 105A-B in any particular manner. In some embodiments, one or more of the actions performed by the identity management system 100 in the examples of FIGS. 2A-D may be performed by the identity management agent 105A and/or 105B, or vice versa.

For instance, in some embodiments, the DID and/or the DID document may be generated, at act 290, by the identity management agent 105B. At act 295, the identity management agent 105B may record the DID and/or the related information in a private registry maintained on the child's device. At act 299, the identity management agent 105B may send the DID generated at act 290, and/or the related information, to the identity management agent 105A. Such an illustrative process 200D is shown in FIG. 2D.

In the example of FIG. 2D, a recovery key pair for the child may be generated by the identity management agent 105B at act 290. Recover operations may be performed by the identity management agent 105B in manners similar to those described above for the identity management system 100, and/or processed by the private registry in manners similar to those described above for the identity registry 110.

FIG. 2E shows an illustrative process 250E for establishing a connection between two entities, in accordance with some embodiments. For instance, the process 250E may be used to establish a connection between a parent and a child. This may be done using an identity management agent running on the parent's device (e.g., the illustrative identity management agent 105A in the example of FIG. 1B) and an identity management agent running on the parent's device (e.g., the illustrative identity management agent 105B in the example of FIG. 1B).

At act 252, the identity management agent 105B may send (e.g., at the child's direction) a connection request to the identity management agent 105A. For instance, the identity management agent 105B may display a QR code, with an instruction to have the parent scan the QR code with the parent's device (e.g., the parent's smartphone). The QR code may be configured to cause the parent's device to launch the identity management agent 105A.

Additionally, or alternatively, the identity management agent 105B may prompt the child to enter the parent's email address and/or phone number, and may email and/or text a link to the parent to launch the identity management agent 105A.

In some embodiments, the QR code or the link provided to the parent may encode information that identifies the identity management agent 105B used by the child. For instance, the identity management agent 105B may have an identifier (e.g., a randomly generated alphanumeric string) that cannot be traced to the child's real world identity. This identifier may be encoded into the QR code or the link.

Additionally, or alternatively, a service endpoint for the child (e.g., in a peer-to-peer communication network) may be encoded into the QR code or the link.

At act 254, in response to receiving the connection request at act 252 and/or obtaining the parent's consent to establishing the connection, the identity management agent 105A may generate a key pair in a manner similar to that described above in connection with act 260 in the example of FIG. 2B.

At act 256, the identity management agent 105A may generate a DID and/or an associated DID document in a manner similar to that described above in connection with act 290 in the example of FIG. 2B. In some embodiments, the DID may be a pairwise DID identifying the parent with respect to the child (hereafter, DID-PtoC). The associated DID document may include some suitable information about the parent, such as the public key generated at act 254, a service endpoint for the parent (e.g., in the same peer-to-peer communication network as the service endpoint for the child), etc.

At act 258, the identity management agent 105A may send DID-PtoC and/or related information (e.g., the associated DID document, or information that may be used to resolve DID-PtoC into the associated DID document) to the identity management agent 105B. This may be done in any suitable manner, for example, via a message to the service endpoint for the child in the peer-to-peer communication network, or via a direct connection between the parent's device and the child's device (e.g., using a wired or wireless communication protocol such as Ethernet, Bluetooth, etc.).

At act 260, the identity management agent 105B may generate a key pair in a manner similar to that described above in connection with the example of FIG. 2B.

At act 262, the identity management agent 105B may generate a DID and/or an associated DID document in a manner similar to that described above in connection with act 290 in the example of FIG. 2B. In some embodiments, the DID may be a pairwise DID identifying the child with respect to the parent (hereafter, DID-CtoP). The associated DID document may include some suitable information about the child, such as the public key generated at act 260, the service endpoint for the child, etc.

At act 264, the identity management agent 105B may record DID-CtoP and/or related information (e.g., the associated DID document itself, and/or information that may be used to resolve DID-CtoP into the associated DID document) in a private registry maintained on the child's device. Additionally, or alternatively, the identity management agent 105B may record DID-PtoC and/or related information (e.g., the associated DID document itself, and/or information that may be used to resolve DID-PtoC into the associated DID document) in the private registry.

At act 266, the identity management agent 105B may send DID-CtoP and/or the related information to the identity management agent 105A. This may be done in any suitable manner, for example, via a message to the service endpoint for the parent in the peer-to-peer communication network, or via a direct connection between the parent's device and the child's device (e.g., using a wired or wireless communication protocol such as Ethernet, Bluetooth, etc.).

At act 268, the identity management agent 105A may record DID-PtoC and/or the related information in a private registry maintained on the parent's device. Additionally, or alternatively, the identity management agent 105A may record DID-CtoP and/or the related information in the private registry.

As discussed above, the inventors have recognized and appreciated that it may be desirable for a user to have multiple DIDs. For instance, the user may have different DIDs for different types of activities, such as one or more DIDs for online gaming, one or more DIDs for social media, one or more DIDs for online shopping, etc. In this manner, it may be more challenging for a data vendor to link different activities of the user, and therefore privacy may be improved.

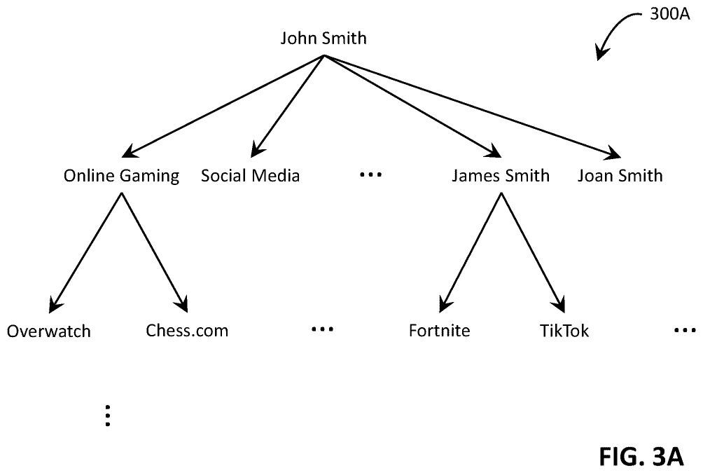

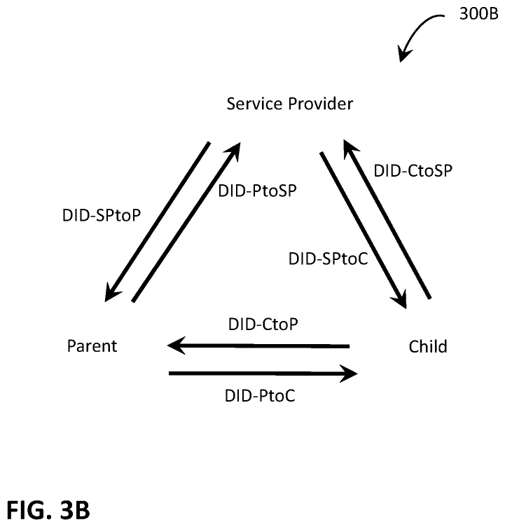

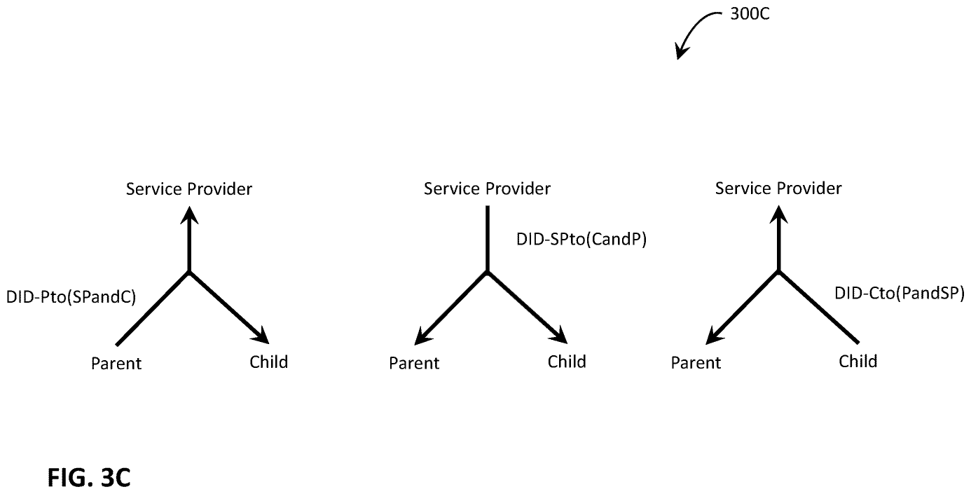

FIG. 3A shows an illustrative collection 300A of DIDs, in accordance with some embodiments. For instance, the collection 300A may be associated with an account at the illustrative identity management system 100 in the example of FIG. 1A, such as an account established via the illustrative process 200A in the example of FIG. 2A.

In this example, the collection 300A has a root DID for a user, John Smith. The root DID may have one or more child DIDs, such as a DID for online gaming, a DID for social media, a DID for online shopping, etc. The root DID may represent the user's identity, whereas a child DID may represent a profile of the identity.

In some embodiments, a child DID may itself have one or more child DIDs. For instance, the DID for online gaming may have one or more child DIDs corresponding, respectively, to one or more games (e.g., Overwatch, Chess.com, etc.).

In some embodiments, the identity management system 100 may add a DID generated for a child (e.g., via the illustrative process 250B in the example of FIG. 2B) as a profile under an identity of the child's parent. For instance, in the example of FIG. 3A, John Smith may have two children, James Smith and Joan Smith. The root DID may have a child DID for each of the children. The child DID for a child (e.g., James Smith) may itself have multiple child DIDs corresponding, respectively, to multiple activities (e.g., Fortnite, TikTok, etc.).

The inventors have recognized and appreciated that, by adding a child's DID to a parent's DID collection, the parent may be able to manage the child's account in the same way the parent's own profiles are managed. This may simplify user experience and/or strengthen parental control. However, it should be appreciated that aspects of the present disclosure are not so limited.

FIG. 3B shows another illustrative collection 300B of DIDs, in accordance with some embodiments. In this example, the collection 300B includes the illustrative pairwise DIDs, DID-PtoC and DID-CtoP, in the example of FIG. 2E. Thus, DID-PtoC may identify a parent with respect to a child, whereas DID-CtoP may identify the child with respect to the parent.

Additionally, or alternatively, the collection 300B includes pairwise DIDs, DID-SPtoC and DID-CtoSP. DID-SPtoC may identify a service provider with respect to the child, whereas DID-CtoSP may identify the child with respect to the service provider. DID-SPtoC and DID-CtoSP may be established between the service provider and the child using a process similar to the illustrative process 250E in the example of FIG. 2E.

Additionally, or alternatively, the collection 300B includes pairwise DIDs, DID-SPtoP and DID-PtoSP. DID-SPtoP may identify the service provider with respect to the parent, whereas DID-PtoSP may identify the parent with respect to the service provider. DID-SPtoP and DID-PtoSP may be established between the service provider and the parent using a process similar to the illustrative process 250E in the example of FIG. 2E.

FIG. 3C shows another illustrative collection 300C of DIDs, in accordance with some embodiments. In this example, the collection 300C includes 3-way DIDs, DID-Pto(SPandC), DID-SPto(CandP), and DID-Cto(PandSP). DID-Pto(SPandC) may identify a parent with respect to a service provider and a child, DID-SPto(CandP) may identify the service provider with respect to the child and the parent, and DID-Cto(PandSP) may identify the child with respect to the parent and the service provider. DID-Pto(SPandC), DID-SPto(CandP), and DID-Cto(PandSP) may be established among the service provider, the child, and the parent using a process similar to the illustrative process 250E in the example of FIG. 2E (e.g., using multicast messages, and/or multiple unicast messages directed to respective recipients).

The inventors have recognized and appreciated that 3-way DIDs may be beneficial, because the service provider may be able to select whether a message is to be decrypted by the parent only, the child only, or both. In this manner, the service provider may allow the parent to monitor communications between the service provider and the child. However, it should be appreciated that aspects of the present disclosure are not limited to using 3-way DIDs, or any N-way DID at all.

It should also be appreciated that aspects of the present disclosure are not limited to any particular collection of DIDs, or any DID at all. In some embodiments, new N-way DIDs may be established for each communication session among N participants.

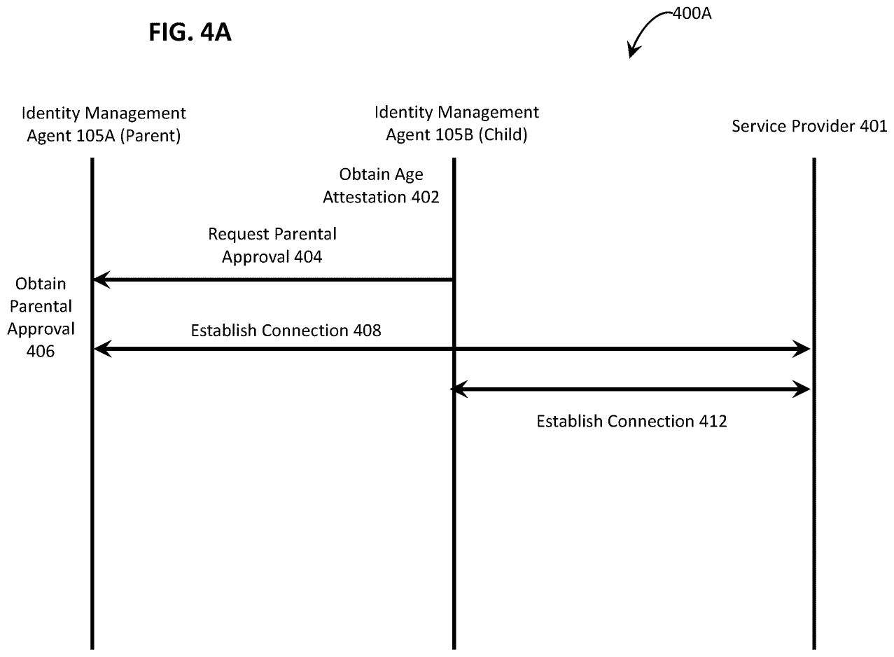

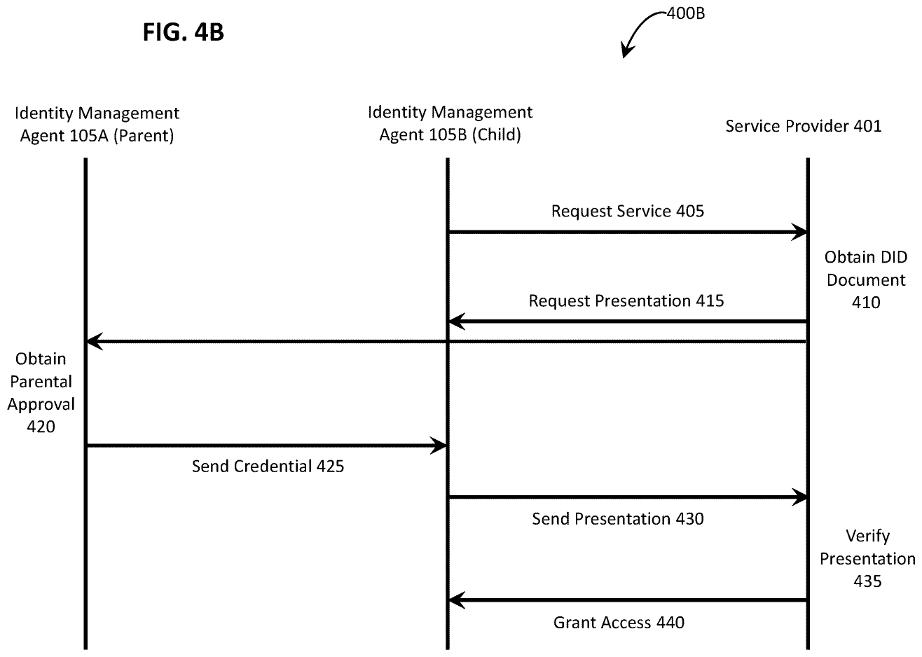

FIG. 4A shows an illustrative process 400A for verifiable approval, in accordance with some embodiments. For instance, after onboarding via the illustrative process 250B in the example of FIG. 2B or the illustrative process 250D in the example of FIG. 2D, or establishing a connection with a parent via the illustrative process 250E in the example of FIG. 2E, a child may wish to establish a connection with a service provider 401, which may be, for example, an online gaming platform. An identity management agent running on the child's device (e.g., the illustrative identity management agent 105B in the example of FIG. 1B) may determine that the service provider 401 accepts connection requests from children only with parental approval. Accordingly, the identity management agent 105B may initiate the process 400B to obtain approval from the parent.

At act 402, the identity management agent 105B may obtain an age attestation from the child in a manner similar to that described above in connection with act 255 in the example of FIG. 2B.

In this example, the child's self-attestation may indicate that the child is not an adult. Accordingly, at act 404, the identity management agent 105B may request parental approval. For instance, the identity management agent 105B may prompt the child to identify an existing connection as having parental authority, and may send the request via a message to a service endpoint indicated in a DID document associated with the connection. In some embodiments, the message may be encrypted using a public key retrieved from the DID document associated with the connection.

The request for parental approval may include any suitable information, such as a name of the child, a name and/or description of the service provider 401, one or more terms and/or conditions offered by the service provider 401, a service endpoint of the service provider 401 (e.g., in the same peer-to-peer communication network as the service endpoint of the parent), etc.

At act 406, an identity management agent running on the parent's device (e.g., the illustrative identity management agent 105A in the example of FIG. 1B) may obtain parental approval in a manner similar to that described above in connection with act 270 in the example of FIG. 2B. However, there may be no involvement by the illustrative identity management system 100 in the example of FIG. 1A. One or more tasks performed by the identity management system 100 may instead be performed by the identity management agent 105A.

For instance, the identity management agent 105A may prompt the parent to attest that the parent has authority to grant approval for the child. Additionally, or alternatively, the identity management agent 105A may display information regarding the service provider 401, and may prompt the parent to grant approval.

In response to obtaining the parent's approval, the identity management agent 105A may, at act 408, establish a connection with the service provider 401. This may be done in any suitable manner, for instance, using a process similar to the illustrative process 250E in the example of FIG. 2E (except a connection request may be sent via a message to the service provider 401's service endpoint in the peer-to-peer communication network).

In some embodiments, as a result of act 408, pairwise DIDs may be established between the parent and the service provider 401 (e.g., the illustrative pairwise DIDs, DID-PtoSP and DID-SPtoP, in the example of FIG. 3B).

Additionally, or alternatively, the identity management agent 105A may request that the service provider 401 establish a connection with the child. This request may be sent via a message to the service endpoint of the service provider 401, and may identify the child's service endpoint in the same peer-to-peer communication network. In some embodiments, the request may be signed using a private key associated with DID-PtoSP.

In response, the service provider 401 may, at act 412, establish a connection with the identity management agent 105B. This may be done in any suitable manner, for instance, using a process similar to the illustrative process 250E in the example of FIG. 2E (except a connection request may be sent via a message to the child's service endpoint in the peer-to-peer communication network).

In some embodiments, as a result of act 412, pairwise DIDs may be established between the child and the service provider 401 (e.g., the illustrative pairwise DIDs, DID-CtoSP and DID-SPtoC, in the example of FIG. 3B).

It should be appreciated that aspects of the present disclosure are not limited to using any pairwise DID, or any N-way DID at all. In some embodiments, the identity management agent 105A may initiate a 3-way process to establish the illustrative 3-way DIDs, DID-Pto(SPandC), DID-SPto(CandP), and DID-Cto(PandSP) in the example of FIG. 3C.

FIG. 4B shows an illustrative process 400B for verifiable approval, in accordance with some embodiments. For instance, a child may wish to access a service, such as an online game offered by the illustrative service provider 401 in the example of FIG. 4A. Accordingly, an identity management agent running on the child's device (e.g., the illustrative identity management agent 105B in the example of FIG. 1B) may initiate the process 400B to obtain approval from a parent of the child.

In some embodiments, the process 400B may be performed after the child has been onboarded with the illustrative identity management system 100 in the example of FIG. 1A via the illustrative process 250B in the example of FIG. 2B or the illustrative process 250D in the example of FIG. 2D. Additionally, or alternatively, the process 400B may be performed after the child has established a connection with the service provider 401 via the illustrative process 400A in the example of FIG. 4A.

At act 405, the identity management agent 105B may send a request to the service provider 401 to indicate that the child wishes to access a service. In some embodiments, the request may include a DID of the child. As an example, the request may include a DID that is generated when the child is onboarded with the identity management system 100 via the process 250B or 250D (e.g., the DID at the node labeled James Smith in the example of FIG. 3A). As another example, the request may include a DID generated for the requested service (e.g., the DID at the node labeled Fortnite, under James Smith, in the example of FIG. 3A). As yet another example, the request may include a DID generated for a category of services to which the requested service belongs.

As yet another example, the request may include a pairwise DID identifying the child with respect to the service provider 401 (e.g., DID-CtoSP in the example of FIG. 3B). As yet another example, the request may include a 3-way DID identifying the child with respect to the parent and the service provider 401 (e.g., DID-Cto(PandSP) in the example of FIG. 3C).

In response to the service request received at act 405, the service provider 401 may, at act 410, use the DID in the received request to obtain an associated DID document. For instance, the service provider may look up the associated DID document from an identity registry, such as the illustrative identity registry 110 in the example of FIG. 1A.

Additionally, or alternatively, the service provider 401 may look up, from the identity registry 110, information related to the DID, and may use that information to resolve the DID into the DID document. As an example, the service provider 401 may look up a sequence of operations performed with respect to the DID (e.g., Create, Update, Recover, Deactivate, etc.), and may construct the DID document by applying the sequence of operations in the appropriate order.

Additionally, or alternatively, the associated DID document may have been provided to the service provider 401 prior to the process 400B (e.g., via a process similar to the illustrative process 250E in the example of FIG. 2E). Thus, the associated DID document may be looked up from a private registry that is maintained locally by the service provider 401.

At act 415, the service provider 401 may send a presentation request, which may indicate one or more items of information needed to provide access to the requested service. For instance, the requested service may be an online game, and the service provider 401 may request that the child's avatar in the online game be identified.

In some embodiments, communications between the identity management agent 105B and the service provider 401 may take place via a secure channel. For instance, messages between the identity management agent 105B and the service provider 401 may be encrypted and/or authenticated. Any suitable secure channel may be used, such as a channel implementing a DIDComm Messaging specification provided by DIF.

Thus, the identity management agent 105B and the service provider 401 may be able to communicate without exposing data to any centralized service. However, it should be appreciated that aspects of the present disclosure are not limited to using DIDComm Messaging or any other peer-to-peer communication protocol.

In some embodiments, the service provider 401 may publish a DID in a suitable manner (e.g., on a web site of the service provider 401). Additionally, or alternatively, the service provider 401's DID (e.g., DID-SPtoC in the example of FIG. 3B, or DID-SPto(CandP) in the example of FIG. 3C) may have been provided to the identity management agent 105B prior to the process 400B (e.g., via a process similar to the illustrative process 250E in the example of FIG. 2E).

Accordingly, the identity management agent 105B may use the service provider 401's DID to obtain an associated DID document in a manner similar to that described above in connection with act 410.

In some embodiments, the service request of act 405 may be sent via a DIDComm message to a service endpoint indicated in the service provider 401's DID document. The DIDComm message may be encrypted using a public key indicated in the service provider 401's DID document, and the service provider 401 may use a corresponding private key to decrypt the message.

Likewise, the child's DID document, obtained at act 410, may indicate a service endpoint for receiving DIDComm messages. Accordingly, the service provider 401 may package the presentation request into a DIDComm message, and send the DIDComm message to the service endpoint indicated in the child's DID document. The DIDComm message may be encrypted using a public key indicated in the child's DID document, and the identity management agent 105B may use a corresponding private key to decrypt the DIDComm message.

In some embodiments, the service endpoint for the child's DID may be the identity management system 100. Upon receiving the DIDComm message from the service provider 401, the identity management system 100 may determine whether an intended recipient of the DIDComm message is a child.

In this example, the identity management system 100 determines that the intended recipient is indeed a child. Accordingly, the identity management system 100 may identify a parent of the child (e.g., using the illustrative DID collection 300A in the example of FIG. 3A), and may forward the DIDComm message from the service provider 401 to both the identity management agent 105B (on the child's device) and the illustrative identity management agent 105A in the example of FIG. 1A (on the parent's device).

The inventors have recognized and appreciated that, because the DIDComm message from the service provider 401 is encrypted, the presentation request may not be exposed to the identity management system 100. However, aspects of the present disclosure are not limited to using the identity management system 100 as a service endpoint. Any other system that is configured to process DIDComm messages may be used, in addition to, or instead of, the identity management system 100. For instance, a DIDComm message may include an unencrypted portion (e.g., an unencrypted header) that stores routing information in a suitable format. Such routing information may indicate whether the intended recipient is a child, and/or may identify a parent of the child.

Additionally, or alternatively, the parent may have a DID (e.g., DID-PtoSP in the example of FIG. 3B, or DID-Pto(SPandC) in the example of FIG. 3C) that has been provided to the service provider 401 prior to the process 400B (e.g., via a process similar to the illustrative process 250E in the example of FIG. 2E).

Accordingly, the service provider 401 may use the parent's DID to obtain an associated DID document in a manner similar to that described above in connection with act 410, and may direct the DIDComm message with the presentation request to a service endpoint indicated in the parent's DID document, in addition to, or instead of, the service endpoint indicated in the child's DID document.

In some embodiments, the DIDComm message from the service provider 401 may be encrypted using multiple public keys. For instance, as described in connection with act 290 in the example of FIG. 2B, the child's DID document may store both the child's public key and the parent's public key.

Additionally, or alternatively, the DIDComm message may be encrypted using a public key indicated in the parent's DID document (e.g., for DID-PtoSP in the example of FIG. 3B, or DID-Pto(SPandC) in the example of FIG. 3C), as well as a public key indicated in the child's DID document (e.g., for DID-CtoSP in the example of FIG. 3B, or DID-Cto(SPandP) in the example of FIG. 3C).

Accordingly, the DIDComm message may be encrypted in such a way that either the child's private key or the parent's private key may be used to decrypt the DIDComm message.

Thus, at act 420, the identity management agent 105A may use the parent's private key to decrypt the DIDComm message, and may display to the parent, a name and/or a description of the requested service. Additionally, or alternatively, the identity management agent 105A may display to the parent, the information requested by the service provider 401 (e.g., the child's avatar in the online game).

In response to the parent approving the requested service and/or collection of the requested information, the identity management agent 105A may, at act 425, send a credential to the identity management agent 105B. The credential may be sent in any suitable manner, for instance, via a DIDComm message encrypted using the child's public key (e.g., a public key generated when the child is onboarded with the identity management system 100 via the process 250B or 250D, or a public key corresponding to DID-CtoP in the example of FIG. 3B, or DID-Cto(SPandP) in the example of FIG. 3C).

In some embodiments, the credential may indicate the parent's approval (hereafter, the parental approval credential), and may be signed using the parent's private key (e.g., a private key that is generated when the parent is onboarded with the identity management system 100 via the illustrative process 250A in the example of FIG. 2A or the illustrative process 250C in the example of FIG. 2C, or a private key corresponding to DID-PtoC in the example of FIG. 3B, or DID-Pto(SPandC) in the example of FIG. 3C). For instance, the parental approval credential may be a data structure prepared according to a Verifiable Credential specification provided by DIF. Below is an example of such a credential.

| 1 | ∨ | “credentialSubject”: { | | |
|---|---|---|---|---|
| 2 | ∨ | \| | “allowedService”: { | |
| 3 | | \| | \| | “id”: “did:evan:onlinegame”, |
| 4 | | \| | \| | “sharedData”: [“equsId”, “avatar”] |

| | | |
|---|---|---|
| 5 | \| | } |

| | |
|---|---|
| 6 | }, |

In some embodiments, in response to receiving the DIDComm message from the identity management agent 105A at act 425, the identity management agent 105B may use the child's private key (e.g., a private key generated when the child is onboarded with the identity management system 100 via the process 250B or 250D, or a private key corresponding to DID-CtoP in the example of FIG. 3B, or DID-Cto(SPandP) in the example of FIG. 3C) to decrypt the DIDComm message, thereby obtaining the parental approval credential.

In the above example, the credential may not include any DID of the child, which may protect the child's privacy. However, it should be appreciated that aspects of the present disclosure are not so limited.

At act 430, the identity management agent 105B may send a presentation to the service provider 401. The presentation may be sent in any suitable manner, for instance, via a DIDComm message encrypted using the service provider 401's public key (e.g., a public key published on the service provider 401's web site, or a public key corresponding to DID-SPtoC in the example of FIG. 3B, or DID-SPto(CandP) in the example of FIG. 3C).

In some embodiments, the presentation may include the parental approval credential, and may be signed using the child's private key (e.g., a private key generated when the child is onboarded with the identity management system 100 via the process 250B or 250D, or a private key corresponding to DID-CtoSP in the example of FIG. 3B, or DID-Cto(SPandP) in the example of FIG. 3C). For instance, the presentation may be a data structure prepared according to a Verifiable Presentation specification provided by DIF.

Additionally, or alternatively, the presentation may include a credential for the information requested by the service provider 401 (e.g., the child's avatar in the online game). For instance, the identity management agent 105B may use the child's private key (e.g., a private key generated when the child is onboarded with the identity management system 100 via the process 250B or 250D, or a private key corresponding to DID-CtoSP in the example of FIG. 3B, or DID-Cto(SPandP) in the example of FIG. 3C) to decrypt the DIDComm message received from the service provider 401 at act 415, and may prepare a credential with the information requested by the service provider 401. This credential (hereafter, the user information credential) may be signed using the child's private key (e.g., a private key generated when the child is onboarded with the identity management system 100 via the process 250B or 250D, or a private key corresponding to DID-CtoSP in the example of FIG. 3B, or DID-Cto(SPandP) in the example of FIG. 3C). For instance, like the parental approval credential, the user information credential may be a data structure prepared according to a Verifiable Credential specification provided by DIF.

In some embodiments, in response to receiving the DIDComm message from the identity management agent 105B at act 430, the service provider 401 may use the service provider 401's private key (e.g., a private key corresponding to a public key published on the service provider 401's web site, or a private key corresponding to DID-SPtoC in the example of FIG. 3B, or DID-SPto(CandP) in the example of FIG. 3C) to decrypt the DIDComm message, thereby obtaining the presentation.

At act 435, the service provider 401 may verify the presentation. For instance, the service provider 401 may use the child's public key (e.g., a public key generated when the child is onboarded with the identity management system 100 via the process 250B or 250D, or a public key corresponding to DID-CtoSP in the example of FIG. 3B, or DID-Cto(SPandP) in the example of FIG. 3C) to verify the signature over the presentation.

Additionally, or alternatively, the service provider 401 may use the child's public key (e.g., a public key generated when the child is onboarded with the identity management system 100 via the process 250B or 250D, or a public key corresponding to DID-CtoSP in the example of FIG. 3B, or DID-Cto(SPandP) in the example of FIG. 3C) to verify the signature over the user information credential.

Additionally, or alternatively, the service provider 401 may use the parent's public key (e.g., a public key generated when the parent is onboarded with the identity management system 100 via the process 250A or 250C, or a public key corresponding to DID-PtoSP in the example of FIG. 3B, or DID-Pto(SPandC) in the example of FIG. 3C) to verify the signature over the parental approval credential.

In some embodiments (e.g., as described above in connection with act 290 in the example of FIG. 2B), the child's DID document may store the parent's public key as an approver's public key, without making explicit a relationship between the approver and a subject of the DID, or even that the subject of the DID is a child. In this manner, the service provider 401 may be able to obtain parental approval for a user, without actual knowledge that the user is a child.

In some embodiments, the parental approval credential may include an expiration date. For instance, the parental approval credential may include a field labeled “expirationDate.” Accordingly, the service provider 401 may check a date stored in the “expirationDate” field to confirm that the parental approval credential has not expired.

In some embodiments, the parent may be able to revoke the parental approval credential. For instance, the parental approval credential may include a field labeled “credentialStatus,” which may store a pointer to a revocation registry.

The revocation registry may be implemented in any suitable manner. As an example, the revocation registry may be implemented on a distributed ledger (e.g., using a smart contract), which may provide tamper resistance. Additionally, or alternatively, the revocation registry may be part of, or separate from, the illustrative identity registry 110 in the example of FIG. 1A.

In some embodiments, to revoke the parental approval credential, the identity management agent 105A may send a revocation notice to the revocation registry. The revocation notice may indicate an identifier of the parental approval credential, and may be signed using the parent's private key (e.g., a private key generated when the parent is onboarded with the identity management system 100 via the process 250A or 250C, or a private key corresponding to DID-PtoC in the example of FIG. 3B, or DID-Pto(SPandC) in the example of FIG. 3C).

Additionally, or alternatively, the revocation notice may indicate the parent's DID (e.g., a DID generated when the parent is onboarded with the identity management system 100 via the process 250A or 250C, or DID-PtoC in the example of FIG. 3B, or DID-Pto(SPandP) in the example of FIG. 3C), which may allow the revocation registry to obtain the parent's public key from an associated DID document. The revocation registry may use the parent's public key, thus obtained, to verify the signature over the revocation notice. If the signature is successfully verified, the revocation registry may add the identifier of the parental approval credential to a revocation list.

Accordingly, in some embodiments, to confirm that the parental approval credential has not been revoked, the service provider 401 may check the identifier of the parental approval credential against the revocation list.

Similarly, the child may be able to revoke the user information credential and/or the presentation by sending a revocation notice to the revocation registry. Accordingly, to confirm that the user information credential and/or the presentation have not been revoked, the service provider 401 may check identifier(s) of the user information credential and/or the presentation against the revocation list.

In response to successfully verifying the presentation, the service provider 401 may, at act 440, grant access to the requested service. In some embodiments, such access may be restricted in one or more ways. As an example, if the parental approval credential includes an “expirationDate” field, then the service provider 401 may provide access only until a date indicated in that field.

As another example, the parental approval credential may indicate a particular service offering of the service provider 401. Below is an example of such a credential, where a request identifier is stored in a “requestId” field.

| | |
|---|---|
| 1 | { |
| 2 | “credentialSubject”: { |
| 3 | “allowedService”: { |
| 4 | “id”: “did:evan:onlinegame”, |
| 5 | “sharedData”: [“equsId”, “avatar”], |
| 6 | “requestId”: “123-567-890” |
| 7 | } |
| 8 | } |
| 9 | } |

Accordingly, the service provider 401 may provide access only to one or more service offerings associated with a service request identified in the “requestId” field in the parental approval credential.

As another example, the parental approval credential may indicate a category of services that are permitted/not permitted. For instance, the parental approval credential may indicate an ESRB rating. Below is an example of such a credential.

| | |
|---|---|
| 1 | { |
| 2 | “credentialSubject”: { |
| 3 | “allowedService”: { |
| 4 | “sharedData”: [“equsId”, “avatar”], |
| 5 | “esrbRating”: “T” |
| 6 | } |
| 7 | } |
| 8 | } |

Accordingly, the service provider 401 may provide access to all service offerings having an ESRB rating “T” or lower (e.g., including E and E10+). In this manner, the child may be able to access different service offerings within the category after having obtained parental approval just once, for the entire category.

As another example, the parental approval credential may indicate when the child may access one or more indicated services, and/or how much time and/or money the child may spend on a periodic basis (e.g., daily, weekly, monthly, etc.). Below is an example of such a credential.

| | |
|---|---|
| 1 | { |
| 2 | ″credentialSubject″: { |
| 3 | ″allowedService″: { |
| 4 | ″sharedData″: [″equsId″, ″avatar″], |
| 5 | ″esrbRating″: ″T” |
| 6 | }, |
| 7 | ″allowedTimes″: { |
| 8 | ″days″: [″MON″, ″TUE″, ″WED″], |
| 9 | ″hours″: 4 |
| 10 | } |
| 11 | } |
| 12 | } |
| | . |

Accordingly, the service provider 401 may provide access only Monday through Wednesday each week, for up to 4 hours per day.

The inventors have recognized and appreciated that, because the “expirationDate” field, the “credentialStatus” field, the “requestId” field, the “esrbRating” field, and/or the “allowedTimes” field(s) are part of the parental approval credential, which is signed using the parent's private key, the service provider 401 may be assured that such field(s) have not been improperly altered. However, it should be appreciated that aspects of the present disclosure are not limited to having any particular field in a parental approval credential, or any parental approval credential at all.

Although certain implementation details are described above in connection with FIG. 4B, it should be appreciated that such details are provided solely for purposes of illustration. For example, aspects of the present disclosure are not limited to storing any particular number of one or more public keys in a child's DID document. In some instances, a child may have two parents who have onboarded with the identity management system 100. Accordingly, the child's DID document may store a public key from each parent, and may indicate that certain actions require approval from both parents, certain other actions require approval from at least one parent, and/or yet other actions do not require parental approval.

Furthermore, although online games are mentioned above in connection with FIG. 4B, it should be appreciated that one or more of the techniques described herein may be used to obtain approval for any type of service. For instance, a requested service may be a service provided by a computing device such as a gaming console. Additionally, or alternatively, a requested service may be a service provided by a brick-and-mortar establishment, such as a bank, a restaurant, or a recreational facility (e.g., a concert venue, a paintball field, a skating rink, etc.). Additionally, or alternatively, a requested service may be a service provided by a government agency, such as a department of motor vehicles.

Further still, although parental approval is discussed throughout, it should be appreciated that aspects of the present disclosure are not limited to any particular type of approval, or any approval at all. In some embodiments, a user may respond to a service provider's request with a presentation that includes an identification credential, such as a credential issued by a know-your-customer (KYC) provider. Upon successfully verifying the identification credential (e.g., using the KYC provider's public key), the service provider may provide a requested service, without requiring the user to provide an approval credential.

Illustrative configurations of various aspects of the present disclosure are provided below.
1. A computer-implemented method for obtaining approval, the method comprising acts of: receiving a presentation associated with a user requesting access to a selected service, the presentation comprising a user information credential and an approval credential; using a user public key associated with the user to verify the presentation and the user information credential; using an approval public key associated with the user to verify the approval credential; and in response to successfully verifying the user information credential and the approval credential, causing the selected service to be provided to the user.
2. The method of configuration 1, further comprising an act of: using a decentralized identifier associated with the user to obtain the user public key and the approval public key.
3 The method of configuration 2, further comprising acts of: receiving, from the user, a request for the selected service; and obtaining, based on the request, the decentralized identifier associated with the user.
4. The method of configuration 2, wherein: the decentralized identifier is used to access information from an identity registry; and the accessed information is used to obtain the user public key and the approval public key.
5. The method of configuration 4, wherein: the information accessed from the identity registry comprises a sequence of operations; the sequence of operations are applied to generate a document associated with the decentralized identifier; and the user public key and the approval public key are obtained from the document associated with the decentralized identifier.
6. The method of configuration 4, further comprising acts of: using the information accessed from the identity registry to identify a service endpoint associated with the user requesting access to the selected service; and sending a presentation request to the service endpoint.
7 The method of configuration 6, wherein: the presentation request is routed by the service endpoint to a device associated with the user and a device associated with an approver; the user information credential and the presentation are generated by the device associated with the user; and the approval credential is generated by the device associated with the approver and sent to the device associated with the user.
8 The method of configuration 1, wherein: the approval credential comprises at least one approval selected from a group consisting of: an approved service; an approved category of services; a time limit; and a spending limit.
9. A computer-implemented method for obtaining approval, the method comprising acts of: receiving, from an approver, a request to generate a decentralized identifier for a user, the request comprising a public key associated with the user; using a public key associated with the approver to verify a signature purportedly generated by the approver over the request; and in response to successfully verifying the signature: generating a decentralized identifier for the user; and binding the public key associated with the user to the decentralized identifier generated for the user.
10. The method of configuration 9, wherein: binding the public key associated with the user to the decentralized identifier comprises recording, with an identity registry, the decentralized identifier along with the public key associated with the user.
11. The method of configuration 9, wherein: the public key associated with the user is generated by the user and sent to the approver.
12. The method of configuration 9, further comprising acts of: matching the request from the approver to the user; and sending the decentralized identifier to the user.
13. The method of configuration 12, further comprising an act of: receiving, from the user, a notification comprising the public key associated with the user, wherein: the public key associated with the user is used to match the request from the approver to the user.
14. The method of configuration 12, further comprising an act of: receiving, from the user, identity information regarding the approver; and the identity information regarding the approver is used to match the request from the approver to the user.
15. A system comprising: at least one processor; and at least one computer-readable storage medium having stored thereon instructions which, when executed, program the at least one processor to perform the method according to any of configurations 1-14.
16. At least one computer-readable storage medium having stored thereon instructions which, when executed, program at least one processor to perform the method according to any of configurations 1-14.

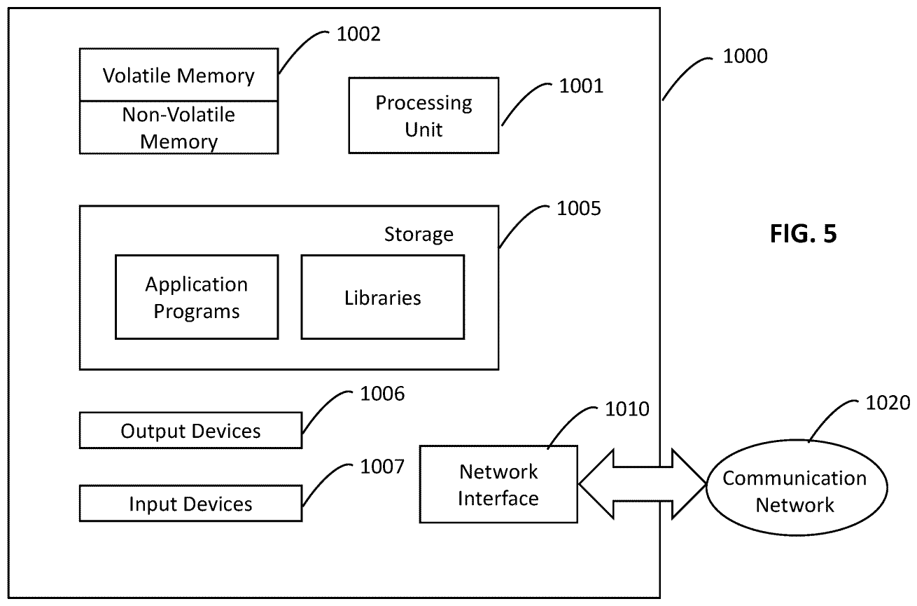

FIG. 5 shows, schematically, an illustrative computer 1000 on which any aspect of the present disclosure may be implemented.

In the example of FIG. 5, the computer 1000 includes a processing unit 1001 having one or more computer hardware processors and one or more articles of manufacture that comprise at least one non-transitory computer-readable medium (e.g., a memory 1002) that may include, for example, volatile and/or non-volatile memory. The memory 1002 may store one or more instructions to program the processing unit 1001 to perform any of the functions described herein. The computer 1000 may also include other types of non-transitory computer-readable media, such as a storage 1005 (e.g., one or more disk drives) in addition to the memory 1002. The storage 1005 may also store one or more application programs and/or resources used by application programs (e.g., software libraries), which may be loaded into the memory 1002. To perform any of the illustrative functionalities described herein, processing unit 1001 may execute one or more processor-executable instructions stored in the one or more non-transitory computer-readable media (e.g., the memory 1002, the storage 1005, etc.), which may serve as non-transitory computer-readable media storing processor-executable instructions for execution by the processing unit 1001.

The computer 1000 may have one or more input devices and/or output devices, such as devices 1006 and 1007 illustrated in FIG. 5. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text.

In the example of FIG. 5, the computer 1000 also includes one or more network interfaces (e.g., network interface 1010) to enable communication via various networks (e.g., network 1020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer-readable media) encoded with one or more programs that, when executed on one or more processors, perform methods that implement the various embodiments of the present disclosure described above. The computer-readable medium or media may be portable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium so that the locations convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

1. A computer-implemented method for obtaining approval, the method comprising acts of:
receiving a presentation associated with a user requesting access to a selected service, the presentation comprising a user information credential and an approval credential;
using a user public key associated with the user to verify the presentation and the user information credential;
using an approval public key associated with the user to verify the approval credential; and
in response to successfully verifying the user information credential and the approval credential, causing the selected service to be provided to the user.

2. The method of claim 1, further comprising an act of:
using a decentralized identifier associated with the user to obtain the user public key and the approval public key.

3. The method of claim 2, further comprising acts of:
receiving, from the user, a request for the selected service; and
obtaining, based on the request, the decentralized identifier associated with the user.

4. The method of claim 2, wherein:
the decentralized identifier is used to access information from an identity registry; and
the accessed information is used to obtain the user public key and the approval public key.

5. The method of claim 4, wherein:
the information accessed from the identity registry comprises a sequence of operations;
the sequence of operations are applied to generate a document associated with the decentralized identifier; and
the user public key and the approval public key are obtained from the document associated with the decentralized identifier.

6. The method of claim 4, further comprising acts of:
using the information accessed from the identity registry to identify a service endpoint associated with the user requesting access to the selected service; and
sending a presentation request to the service endpoint.

7. The method of claim 6, wherein:
the presentation request is routed by the service endpoint to a device associated with the user and a device associated with an approver;
the user information credential and the presentation are generated by the device associated with the user; and
the approval credential is generated by the device associated with the approver and sent to the device associated with the user.

8. The method of claim 1, wherein:
the approval credential comprises at least one approval selected from a group consisting of:
an approved service;
an approved category of services;
a time limit; and
a spending limit.

9-14. (canceled)

15. A system comprising:
at least one processor; and
at least one computer-readable storage medium having stored thereon instructions which, when executed, program the at least one processor to perform a method, the method comprising:
receiving a presentation associated with a user requesting access to a selected service, the presentation comprising a user information credential and an approval credential;
using a user public key associated with the user to verify the presentation and the user information credential;
using an approval public key associated with the user to verify the approval credential; and
in response to successfully verifying the user information credential and the approval credential, causing the selected service to be provided to the user.

16. (canceled)

17. The system of claim 15, wherein the method further comprises:
using a decentralized identifier associated with the user to obtain the user public key and the approval public key.

18. The system of claim 17, wherein the method further comprises:
receiving, from the user, a request for the selected service; and
obtaining, based on the request, the decentralized identifier associated with the user.

19. The system of claim 17, wherein:
the decentralized identifier is used to access information from an identity registry; and
the accessed information is used to obtain the user public key and the approval public key.

20. The system of claim 19, wherein:
the information accessed from the identity registry comprises a sequence of operations;
the sequence of operations are applied to generate a document associated with the decentralized identifier; and
the user public key and the approval public key are obtained from the document associated with the decentralized identifier.

21. The system of claim 19, wherein the method further comprises:
using the information accessed from the identity registry to identify a service endpoint associated with the user requesting access to the selected service; and
sending a presentation request to the service endpoint.

22. The system of claim 21, wherein:
the presentation request is routed by the service endpoint to a device associated with the user and a device associated with an approver;
the user information credential and the presentation are generated by the device associated with the user; and
the approval credential is generated by the device associated with the approver and sent to the device associated with the user.

23. The system of claim 15, wherein:
the approval credential comprises at least one approval selected from a group consisting of:
an approved service;
an approved category of services;
a time limit; and
a spending limit.

24. At least one computer-readable storage medium having stored thereon instructions which, when executed, program at least one processor to perform a method, the method comprising:
receiving a presentation associated with a user requesting access to a selected service, the presentation comprising a user information credential and an approval credential;
using a user public key associated with the user to verify the presentation and the user information credential;
using an approval public key associated with the user to verify the approval credential; and
in response to successfully verifying the user information credential and the approval credential, causing the selected service to be provided to the user.
